(19) United States
(12) Patent Application Publication
(10) Pub. No.: US 2023/0132475 A1
(43) Pub. Date: May 4, 2023

(54) METHOD OF OPTIMIZING A DESIGN MODEL

(71) Applicant: FEA-OPT TECHNOLOGY CO., LTD., Zhunan Township (TW)

(72) Inventor: Shen-Yeh CHEN, Zhunan Township (TW)

(21) Appl. No.: 17/453,630

(22) Filed: Nov. 4, 2021

(51) Int. Cl. G06F 30/12

(52) U.S. Cl. CPC G06F 30/12

(57) ABSTRACT

The present application discloses a method of optimizing a design model. The method includes providing the design model in a CAD system, wherein the design model includes an object entity represented by a geometrical data and a topological data; assigning a first label to the object entity in the CAD system; transforming the first label into a second label to establish a first mapping in the CAD system; exporting a first neutral file of the design model including the second label, the geometrical data and the topological data from the CAD system; importing the first neutral file into a CAE system and transforming the second label into a third label to establish a second mapping in the CAE system; analyzing the design model by the CAE system; deriving a first modified geometrical data for the object entity based on the analysis for optimizing the design model by an optimization system; exporting a first data file including the first modified geometrical data for the object entity, and the second label derived from the third label based on the second mapping stored in the CAE system; importing the first data file into the CAD system and transforming the second label into the first label based on the first mapping stored in the CAD system; and replacing the geometrical data of the object entity assigned the first label with the first modified geometrical data in the first data file to generate a first modified design model in the CAD system.

### TECHNICAL FIELD

The present disclosure relates to a method of optimizing a design model, and more particularly, to a method of modifying and optimizing the design model by a neutral file readable and accessible by a CAD system, a CAE system and an optimization system.

### DISCUSSION OF THE BACKGROUND

Computer aided design (CAD) refers to a process of designing an article or a product with assistance of a CAD computer program through illustration of physical properties of the article (such as appearance, structure, texture, etc.) on a screen or monitor. When the article with an initial design profile is prepared, the article is then analyzed for improvement by a computer-aided engineering (CAE) process. CAE refers to a process of simulating effects of different conditions or constraints applied to the article generated by the CAD process with assistance of a CAE computer program. The CAE computer program performs analysis of physical properties of the article (such as strength, stiffness, thermal conductivity, etc.) or design optimization (such as manufacturing cost reduction, weight optimization, etc.).

However, a variety of issues arise during communication between the CAD program and the CAE program, such as data loss or distortion during transmission of the design profile of the article from the CAD program to the CAE program. Therefore, challenges remain in achieving effective analysis and data compatibility.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a method of optimizing a design model. The method includes providing the design model in a CAD system, wherein the design model includes an object entity represented by a geometrical data and a topological data; assigning a first label to the object entity in the CAD system; transforming the first label into a second label to establish a first mapping in the CAD system; exporting a first neutral file of the design model including the second label, the geometrical data and the topological data from the CAD system; importing the first neutral file into a CAE system and transforming the second label into a third label to establish a second mapping in the CAE system; analyzing the design model by the CAE system; deriving a first modified geometrical data for the object entity based on the analysis for optimizing the design model by an optimization system; exporting a first data file including the first modified geometrical data for the object entity and the second label derived from the third label based on the second mapping stored in the CAE system; importing the first data file into the CAD system and transforming the second label into the first label based on the first mapping stored in the CAD system; and replacing the geometrical data of the object entity assigned the first label with the first modified geometrical data in the first data file to generate a first modified design model in the CAD system.

In some embodiments, the topological data of the object entity remains unchanged.

In some embodiments, the first neutral file and the first data file are in a neutral, generic or non-proprietary file format.

In some embodiments, the first neutral file and the first data file are in STEP file format, DWG file format, STL file format or DXT file format.

In some embodiments, the optimization system is external to the CAD system and the CAE system.

In some embodiments, the method further includes actuating the CAE system by a first user scripting prior to the importation of the first neutral file into the CAE system, and actuating the CAD system by a second user scripting prior to the importation of the first data file into the CAD system.

In some embodiments, the method further includes transforming the design model into a mesh model by the CAE system prior to the analysis of the design model.

In some embodiments, a native file in a proprietary file format is generated by or exported from the CAD system during the exportation of the first neutral file.

In some embodiments, only the first neutral file is imported into the CAE system.

In some embodiments, the native file is readable and accessible exclusively by the CAD system, and the first neutral file is readable and accessible by the CAD system and the CAE system.

In some embodiments, the method further includes providing the first modified design model in the CAD system, wherein the first modified design model includes the object entity assigned the first label and represented by the first modified geometrical data and the topological data; exporting a second neutral file of the first modified design model including the second label derived from the first label based on the first mapping, the first modified geometrical data and the topological data from the CAD system; importing the second neutral file into the CAE system; and analyzing the first modified design model by the CAE system.

In some embodiments, the topological data of the first modified object entity remains unchanged.

In some embodiments, the second neutral file is in a neutral, generic or non-proprietary file format.

In some embodiments, the second neutral file is in STEP file format, DWG file format, STL file format or DXT file format.

In some embodiments, the method further includes deriving a second modified geometrical data for the object entity based on the analysis for optimizing the first modified design model by the optimization system; exporting a second data file including the second modified geometrical data for the object entity and the second label derived from the third label based on the second mapping stored in the CAE system; importing the second data file into the CAD system and transforming the second label into the first label based on the first mapping stored in the CAD system; and replacing the first modified geometrical data of the object entity assigned the first label with the second modified geometrical data in the second data file to generate a second modified design model in the CAD system.

In some embodiments, the second modified design model is generated by changing a dimension of the object entity of the first modified design model.

In some embodiments, the replacement of the first modified geometrical data with the second modified geometrical data includes removing the first modified geometrical data and inserting the second modified geometrical data from the second data file.

In some embodiments, the method further includes providing the second modified design model in the CAD system, wherein the second modified design model includes the object entity assigned the first label and represented by the second modified geometrical data and the topological data; exporting a third neutral file of the second modified design model including the second label derived from the first label based on the first mapping stored in the CAD system, the second modified geometrical data and the topological data from the CAD system; importing the third neutral file into the CAE system; and analyzing the second modified design model by the CAE system.

Another aspect of the present disclosure provides a method of optimizing a design model. The method includes providing the design model in a CAD system, wherein the design model includes a first object entity represented by a first geometrical data and a first topological data, and a second object entity represented by a second geometrical data and a second topological data; assigning a first label to the first object entity and a second label to the second object entity in the CAD system; transforming the first label and the second label into a third label and a fourth label, respectively, to establish a first mapping in the CAD system; exporting a neutral file of the design model including the third label, the first geometrical data, the first topological data, the fourth label, the second geometrical data and the second topological data from the CAD system; importing the neutral file into a CAE system and transforming the third label and the fourth label into a fifth label and a sixth label, respectively, to establish a second mapping in the CAE system; analyzing the design model by the CAE system; deriving a modified geometrical data for the first object entity indicated by the fifth label based on the analysis for optimizing the design model by an optimization system; exporting a data file including the modified geometrical data for the first object entity indicated by the third label derived from the fifth label based on the second mapping stored in the CAE system; importing the data file into the CAD system and transforming the third label into the first label based on the first mapping stored in the CAD system; and replacing the first geometrical data of the object entity assigned the first label with the first modified geometrical data in the first data file to generate a modified design model in the CAD system, wherein the first topological data, the second geometrical data, the second topological data remain unchanged.

In some embodiments, the modified design model includes the first object entity represented by the first modified geometrical data and the first topological data, and the second object entity represented by the second geometrical data and the second topological data.

Due to the generation and exportation of the design model in a neutral file format by the CAD system and the importation of the design model in the neutral file format into the CAE system for analysis and optimization, the design model in the neutral file format is readable and accessible by the CAD system and the CAE system, without involving a database or libraries at core levels of the CAD system and the CAE system. Therefore, integration of the CAD system and the CAE system is not required. The CAD system and the CAE system can be operated separately without license or authorization from each other.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIGS. 1 and 2 illustrate, in flowchart diagram form, a method for optimizing a design model in accordance with one embodiment of the present disclosure.

FIG. 3 illustrates, in a schematic diagram, a computer-aided design (CAD) system for generating and modifying a design model in accordance with one embodiment of the present disclosure.

FIG. 4 illustrates, in a schematic diagram, a computer-aided engineering (CAE) system for analyzing a design model generated by the CAD system in accordance with one embodiment of the present disclosure.

FIG. 5 illustrates, in a schematic diagram, an optimization system for deriving a solution that optimizes a design model based on an analysis result from the CAE system in accordance with one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present disclosure.

In the present disclosure, a method of optimizing a design model is disclosed. The design model including an object entity is generated by a CAD system, and a label is assigned to the object entity for identification. The design model is transformed into a neutral file in a neutral file format and then imported by a CAE system for subsequent analysis. Since the neutral file is accessible by both the CAD system and the CAE system without license or authorization from each other, the design model can be modified efficiently by the CAD system and a responsive analysis result of the modified design model can be generated by the CAE system. A complexity of design model optimization is reduced.

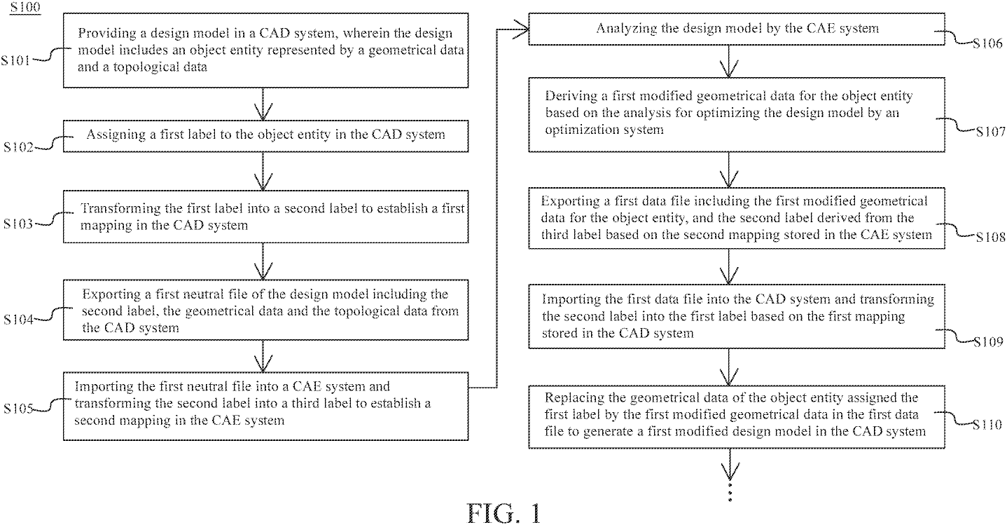

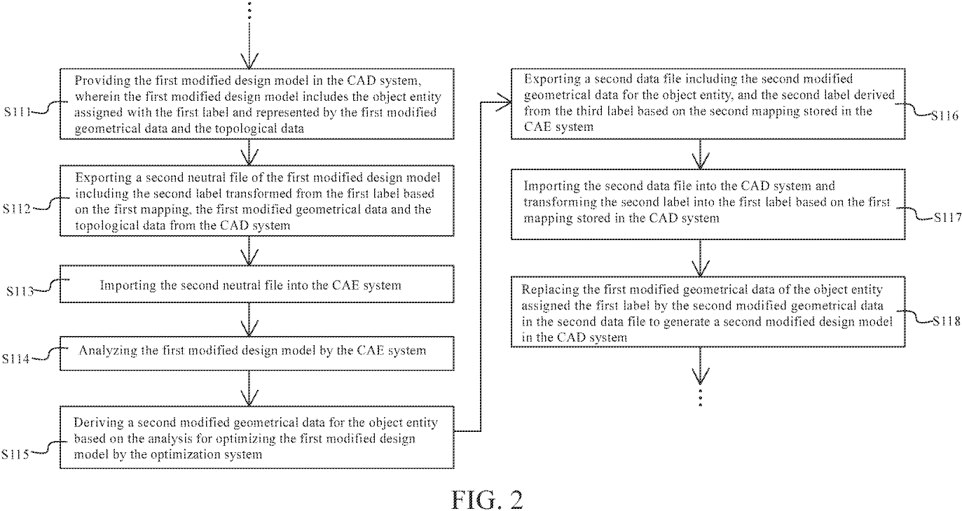

FIGS. 1 and 2 illustrate, in flowchart diagram form, a method S100 for optimizing a design model in accordance with one embodiment of the present disclosure. In some embodiments, the method S100 includes steps S101 to S110 as shown in FIG. 1. In some embodiments, the method S100 includes steps S111 to S118 as shown in FIG. 2. In some embodiments, the method S100 includes steps S101 to S118 as shown in FIGS. 1 and 2.

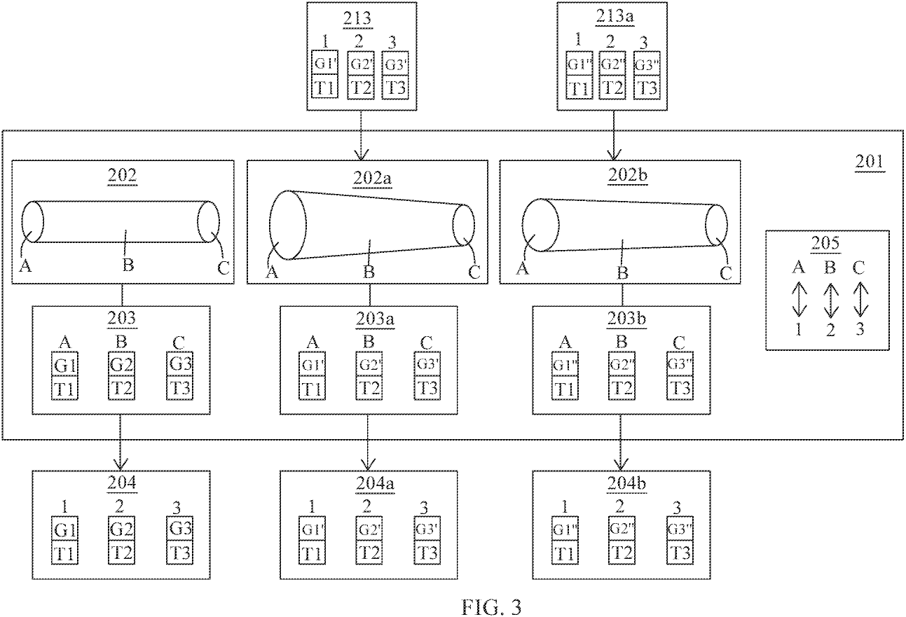

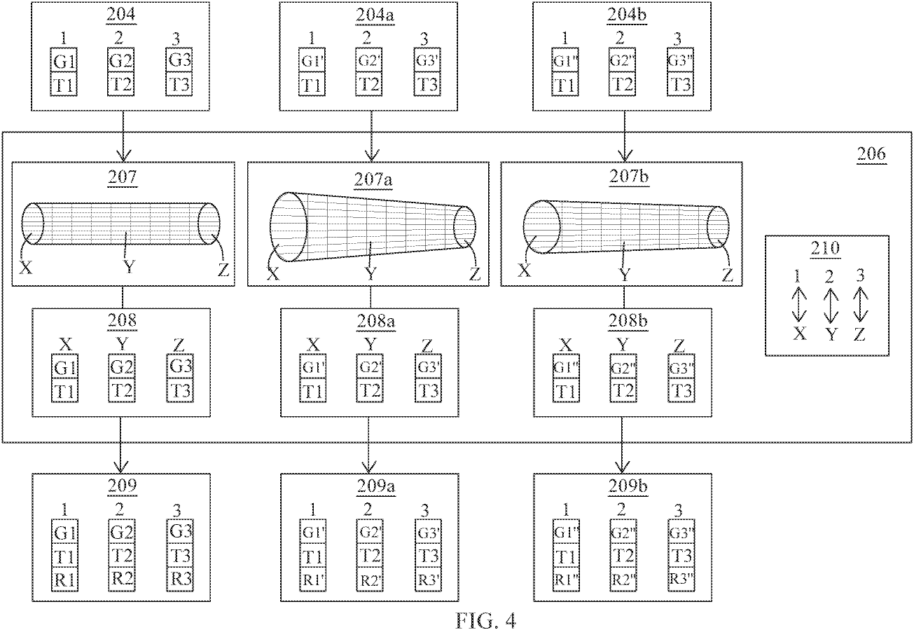

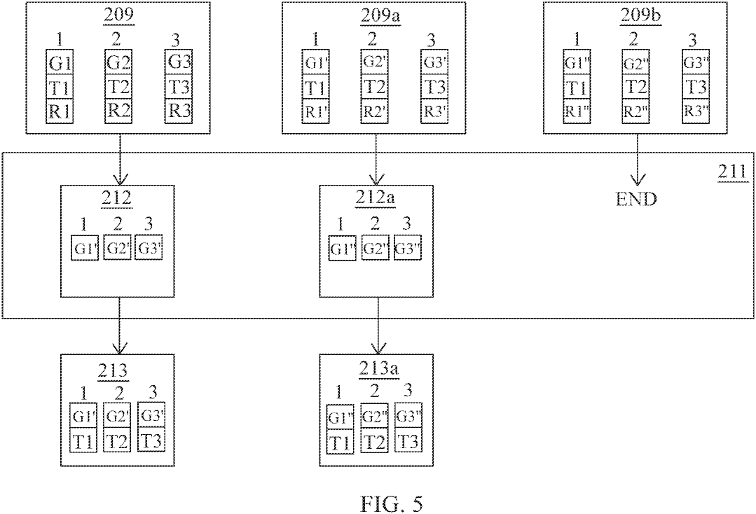

In some embodiments, the method S100 is a design-analysis-optimization cycle for the design model. The design model is optimized and modified consecutively and continuously until the design model becomes an optimal design model. The design-analysis-optimization cycle is terminated when the optimal design model is achieved. In some embodiments, the method S100 is implemented by a CAD system 201 as shown in FIG. 3, a CAE system 206 as shown in FIG. 4 and an optimization system 211 as shown in FIG. 5, which will be discussed in detail below.

With reference to FIGS. 1 and 3, at step S101, a design model 202 is provided in the CAD system 201. In some embodiments, the design model 202 is generated by the CAD system 201. The design model 202 may be an article or a product initially created by a designer and then generated and illustrated by the CAD system 201. In some embodiments, the CAD system 201 includes a CAD software for creating the design model 202. The CAD software may be any suitable commercial application such as AutoCAD, Inventor, SolidWorks, Solid Edge, etc.

In some embodiments, the design model 202 includes various types of information about the article such as structure, shape, dimensions, geometry, materials, topology, etc. In some embodiments, the design model 202 includes an object entity represented by a geometrical data and a topological data. In some embodiments, the object entity is a surface, a solid, an edge, a vertex, etc. In some embodiments, the geometrical data is information about geometry, shape or dimensions of the object entity. In some embodiments, the topological data is information about connectivity, associativity or relationship between the object entities. In some embodiments, the design model 202 is represented by a CAD information file 203. The CAD information file 203 contains the geometrical data and the topological data of each object entity in the design model 202.

For example, as shown in FIG. 3, the design model 202 includes three object entities, including two circular surfaces and one cylindrical solid between the two circular surfaces. The three object entities are represented by geometrical data (G1, G2 and G3, respectively) and topological data (T1, T2 and T3, respectively).

With reference to FIGS. 1 and 3, at step S102, a first label is assigned to the object entity in the CAD system 201. In some embodiments, the assignment is performed in the CAD system 201. In some embodiments, the first label is associated with the geometrical data and the topological data after the assignment. In some embodiments, the first label is readable and accessible exclusively by the CAD system 201. In some embodiments, the CAD information file 203 is readable and accessible exclusively by the CAD system 201.

For example, as shown in FIG. 3, the three object entities of the design model 202 are respectively assigned the first labels (A, B and C). As a result, in the CAD information file 203, the first labels (A, B and C) are associated correspondingly with the geometrical data (G1, G2 and G3) and the topological data T1,T2 and T3) of the object entities.

With reference to FIGS. 1 and 3, at step S 103, the first label is transformed into a second label to establish a first mapping 205 in the CAD system 201. In some embodiments, the first mapping 205 is established and then stored in the CAD system 201. In some embodiments, the second label is readable and accessible by the CAD system 201 as well as other modeling systems generally known in the art. In some embodiments, the first label corresponds to the second label after the transformation and the establishment of the first mapping 205.

For example, as shown in FIG. 3, the first labels (A, B and C) are transformed respectively into the second labels (1, 2 and 3) to establish the first mapping 205. As a result, the second labels (1, 2 and 3) are also associated correspondingly with the geometrical data (G1, G2 and G3) and the topological data (T1, T2 and T3) of the object entities.

With reference to FIGS. 1 and 3, at step S104, a first neutral file 204 of the design model 202 is exported from the CAD system 201. In some embodiments, the first neutral file 204 exported from the CAD system 201 includes the second label, the geometrical data and the topological data. In some embodiments, the first neutral file 204 is in a neutral, generic or non-proprietary file format. In some embodiments, the first neutral file 204 is in STEP file format, DWG file format, STL file format, DXT file format or any other suitable non-proprietary file format. In some embodiments, the first neutral file 204 is readable and accessible by the CAD system 201, as well as other modeling systems and analyzing systems generally known in the art.

In some embodiments, a native file in a proprietary file format is also generated by or exported from the CAD system 201 during the exportation of the first neutral file 204. In some embodiments, the native file is readable and accessible exclusively by the CAD system 201.

For example, as shown in FIG. 3, the first neutral file 204 of the design model 202 is exported from the CAD system 201. The first neutral file 204 includes the second labels (1, 2 and 3), the geometrical data (G1, G2 and G3) and the topological data (T1, T2 and T3). The first neutral file 204 is in a neutral, generic or non-proprietary file format.

With reference to FIGS. 1 and 4, at step S105, the first neutral file 204 is imported into a CAE system 206. The first neutral file 204 exported from the CAD system 201 as shown in FIG. 3 is imported into the CAE system 206 as shown in FIG. 4. Since the first neutral file 204 is in a neutral, generic or non-proprietary file format, the first neutral file 204 is readable and accessible by the CAE system 206. In some embodiments, the design model 202 generated by the CAD system 201 as shown in FIG. 3 is transformed into a mesh model 207 by the CAE system 206 as shown in FIG. 4 after the importation of the first neutral file 204 into the CAE system 206. In some embodiments, the mesh model 207 is generated prior to an analysis of the design model 202 imported into the CAE system 206. In some embodiments, the mesh model 207 is generated by dividing the design model 202 into a plurality of small parts in a grid form for subsequent analysis.

In some embodiments, the second label is transformed into a third label to establish a second mapping 210 during the importation of the first neutral file 204 into the CAE system 206. In some embodiments, the second mapping 210 is established and then stored in the CAE system 206. In some embodiments, the third label is readable and accessible exclusively by the CAE system 206. In some embodiments, the third label corresponds to the second label after the transformation and the establishment of the second mapping 210.

For example, as shown in FIG. 4, the second labels (1, 2 and 3) are transformed respectively into the third labels (X, Y and Z) to establish the second mapping 210. As a result, in a CAE information file 208, the third labels (X, Y and Z) are associated correspondingly with the geometrical data (G1, G2 and G3) and the topological data (T1, T2 and T3) of the object entities in the mesh model 207.

With reference to FIGS. 1 and 4, at step S106, the design model 202 is analyzed by the CAE system 206. In some embodiments, the design model 202 is transformed into the mesh model 207, and the analysis is performed on the mesh model 207. Each object entity is divided into small parts in the grid form and analyzed by the CAE system 206 based on a predetermined condition such as stress, heat, etc.

In some embodiments, the analysis can be any type of engineering analysis generally known in the art, such as finite element analysis (FEA), computational fluid dynamics (CFD), multibody dynamics (MBD), etc. In some embodiments, the CAE system 206 includes a CAE software for analyzing the mesh model 207. The CAE software may be any suitable commercial application such as Abaqus, Moldflow, Matlab, ANSYS, NX, NASTRAN, etc. In some embodiments, an analysis result of the mesh model 207 is obtained from the CAE system 206 for subsequent optimization. In some embodiments, the analysis result is associated with the analysis of the object entity of the mesh model 207. With reference to FIGS. 4 and 5, the analysis result is exported from the CAE system 206 and then imported into an optimization system 211 for optimization of the mesh model 207 or the design model 202.

For example, as shown in FIGS. 4 and 5, the mesh model 207 is analyzed by the CAE system 206, and the analysis results (R1, R2 and R3) are obtained from the CAE system 206. In some embodiments, an analysis result file 209 is generated by the CAE system 206. In some embodiments, the third labels (X, Y and Z) are transformed respectively into the second labels (1, 2 and 3) based on the second mapping 210 stored in the CAE system 206. The analysis result file 209 includes the second labels (1, 2 and 3) and the analysis results (R1, R2 and R3).

In some embodiments, the analysis result file 209 is exported from the CAE system 206 as shown in FIG. 4, and then imported into the optimization system 211 as shown in FIG. 5. In some embodiments, the analysis result file 209 is in a neutral, generic or non-proprietary file format. In some embodiments, the analysis result file 209 is in STEP file format, DWG file format, STL file format, DXT file format or any other suitable non-proprietary file format. In some embodiments, the analysis result file 209 generated by the CAE system 206 is readable and accessible by the optimization system 211.

In some embodiments, the CAE system 206 is actuated prior to the importation of the first neutral file 204 into the CAE system 206. In some embodiments, the CAE system 206 is actuated by a first user scripting such as a text file, a command lines file, a user script, etc.

With reference to FIGS. 1 and 5, at step S107, a first modified geometrical data for the object entity is derived, based on the analysis, for optimizing the design model 202 by the optimization system 211. In some embodiments, the first modified geometrical data is derived based on the analysis performed at the step S106.

In some embodiments, an optimization of the design model 202 is performed by the optimization system 211. In some embodiments, the optimization is performed based on the analysis result from the CAE system 206. In some embodiments, the optimization system 211 includes an optimization software for optimizing the design model 202 based on predetermined constraints. The optimization software may be any suitable commercial application such as Optimus, etc. In some embodiments, the optimization system 211 is external to the CAD system and the CAE system. The optimization system 211 is not integrated with the CAD system and/or the CAE system. The optimization system 211 can be operated separately from the CAD system and/or the CAE system.

For example, as shown in FIG. 5, the analysis result file 209 from the CAE system 206 is imported into the optimization system 211, and then the first modified geometrical data G1′ is derived. In some other geometrical data (G2′ and G3′) are also derived. As a result, in an optimization information file 212, the first modified geometrical data G1′ is associated with the second label 1. In some embodiments, in the optimization information file 212, the other modified geometrical data (G2′ and G3′) are associated with the second labels (2 and 3 respectively). In other words, optimization of the design model 202 is achieved by modifying the geometrical data G1into the first modified geometrical data G1′ according to an optimization result from the optimization system 211. In some embodiments, optimization of the design model 202 is achieved by modifying the other geometrical data (G2 and G3) into the other modified geometrical data (G2′ and G3′ respectively) according to the optimization result from the optimization system 211. In order to obtain an optimized design model, it is necessary to modify the geometrical data G1 for the object entity associated with the second label 1 into the first modified geometrical data G1′. In some embodiments, it is necessary to further modify the other geometrical data G2 for the object entity associated with the second label 2 into the other modified geometrical data G2′, and further modify the other geometrical data G3 for the object entity associated with the second label 3 into the other modified geometrical data G3′.

With reference to FIGS. 1 and 5, at step S108, a first data file 213 is exported from the optimization system 211. In some embodiments, the first data file 213 includes the first modified geometrical data for the object entity, and the second label derived from the third label based on the second mapping 210 in the CAE system 206. In some embodiments, the first data file 213 includes the second label, the first modified geometrical data and the topological data. In some embodiments, the first data file 213 can be in a neutral, generic, non-proprietary file format or a proprietary file format. In some embodiments, the data file 213 is in STEP file format, DWG file format, STL file format, DXT file format or any other suitable non-proprietary file format. In some embodiments, the first data file 213 generated by the optimization system 211 is readable and accessible by the CAD system 201.

For example, as shown in FIG. 5, the first data file 213 is exported from the optimization system 211. The first data file 213 includes the second label 1, the first modified geometrical data G1′ and the topological data T1. In some embodiments, the second label 1 and the topological data T1 are copied from the analysis result file 209 to the first data file 213. In some embodiments, the first data file 213 further includes the second label 2, the other modified geometrical data G2′ and the topological data T2. In some embodiments, the second label 2 and the topological data T2 are copied from the analysis result file 209 to the first data file 213. In some embodiments, the first data file 213 further includes the second label 3, the other modified geometrical data G3′ and the topological data T3. In some embodiments, the second label 3 and the topological data T3 are copied from the analysis result file 209 to the first data file 213.

With reference to FIGS. 1 and 3, at step S 109, the first data file 213 is imported into the CAD system 201. In some embodiments, the first data file 213 generated by the optimization system 211 as shown in FIG. 5 is imported into the CAD system 201 as shown in FIG. 3. In some embodiments, the second label is transformed into the first label based on the first mapping 205 stored in the CAD system 201. The first mapping 205 is established at the step S103. In some embodiments, the transformation of the second label into the first label is performed during the importation of the first data file 213 into the CAD system 201. In some embodiments, the first data file 213 including the second label, the first modified geometrical data and the topological data is imported into the CAD system 201.

In some embodiments, the CAD system 201 is actuated prior to the importation of the first data file 213 into the CAD system 201. In some embodiments, the CAD system 201 is actuated by a second user scripting, such as a text file, a command lines file, a user script, etc.

With reference to FIGS. 1 and 3, at step S110, the geometrical data of the object entity assigned the first label is replaced by the first modified geometrical data in the first data file 213 to generate a first modified design model 202a in the CAD system 201. Since the first label corresponds to the second label based on the first mapping stored in the CAD program 201, the geometrical data associated with the first label is replaced by the first modified geometrical data associated with the second label.

After the replacement of the geometrical data with the first modified geometrical data, the design model 202 is refreshed to become the first modified design model 202a by the CAD system 201. In some embodiments, the design model 202 is optimized to become the first modified design model 202a according to the optimization result from the optimization system 211. In some embodiments, the topological data (T1, T2 and T3) remain unchanged. The topological data (Tl, T2 and T3) in the CAD information file 203 are same as the topological data (T1, T2 and T3) in a first modified CAD information file 203a.

For example, as shown in FIG. 3, the first mapping 205 is established at the step S103 and stored in the CAD system 201. The first labels (A, B and C) correspond respectively to the second labels (1, 2 and 3). Based on the first mapping 205, the geometrical data G1 associated with the first label A is replaced by the first modified geometrical data G1′ associated with the second label 1 in the first data file 213. In some embodiments, based on the first mapping 205, the other geometrical data G2 associated with the first label B is replaced by the other modified geometrical data G2′ associated with the second label 2 in the first data file 213, and the other geometrical data G3 associated with the first label C is replaced by the other modified geometrical data G3′ associated with the second label 3 in the first data file 213. Subsequently, the first modified design model 202a is generated by the CAD system 201. In some embodiments, the replacement of the geometrical data G1 with the first modified geometrical data G1′ is a geometrical change of the object entity assigned the first label A. In some embodiments, the replacement of the geometrical data G1with the first modified geometrical data G1′ represents a change of shape or dimension of the object entity assigned the first label A. In some embodiments, the replacement of the other geometrical data G2 with the other modified geometrical data G2′ is a geometrical change of the object entity assigned the first label B, and the replacement of the other geometrical data G3 with the other modified geometrical data G3′ is a geometrical change of the object entity assigned the first label C.

For example, as shown in FIG. 3, the first modified geometrical data G1′ is an expansion of the object entity assigned the first label A. As such, the object entity assigned the first label A in the first modified design model 202a is enlarged compared to the object entity assigned the first label A in the design model 202. As a result, in the first modified CAD information file 203a, the first label A is now associated with the first modified geometrical data G1′ and the topological data T1. In some embodiments, the rest of the first labels (B and C) are associated with the other modified geometrical data {G2′ and G3′) and the topological data (T2 and T3) correspondingly.

In some embodiments, the method S100 further includes steps S111 to S114 as shown in FIG. 2. In some embodiments, the steps S111 to S114 are implemented after the step S110 discussed above and shown in FIG. 1. In some embodiments, the method S100 can be continuous from steps S101 to S114 as shown in FIGS. 1 and 2.

With reference to FIGS. 2 and 3, at step S 111, the first modified design model 202a is provided in the CAD system 201. In some embodiments, the first modified design model 202a is generated by the CAD system 201. In some embodiments, the first modified design model 202a includes the object entity assigned the first label and represented by the first modified geometrical data and the topological data.

For example, as shown in FIG. 3, the first modified design model 202a includes three object entities, including two circular surfaces and one cylindrical solid between the two circular surfaces. One of the two circular surfaces is enlarged after the step S110, so one object entity is represented by the first modified geometrical data G1′ and the topological data T1, and the other two object entities are represented by the other modified geometrical data (G2′ and G3′ respectively) and topological data (T2 and T3 respectively).

With reference to FIGS. 2 and 3, at step S112, a second neutral file 204a of the first modified design model 202a is exported from the CAD system 201. In some embodiments, the second neutral file 204a exported from the CAD system 201 includes the second label, the first modified geometrical data and the topological data. The second label is derived from the first label based on the first mapping 205 stored in the CAD system 201. In some embodiments, the second neutral file 204a is in a neutral, generic or non-proprietary file format. In some embodiments, the second neutral file 204a is in STEP file format, DWG file format, STL file format, DXT file format or any other suitable non-proprietary file format. In some embodiments, the second neutral file 204a is readable and accessible by the CAD system 201, as well as other modeling systems and analyzing systems generally known in the art. In some embodiments, the second neutral file 204a has a file format similar to that of the first neutral file 204.

In some embodiments, a native file in a proprietary file format is also generated by or exported from the CAD system 201 during the exportation of the second neutral file 204a. In some embodiments, the native file is readable and accessible exclusively by the CAD system 201.

For example, as shown in FIG. 3, the second neutral file 204a of the first modified design model 202a is exported from the CAD system 201. The second neutral file 204a includes the second labels (1, 2 and 3), the first modified geometrical data Gl′, the other geometrical data (G2′ and G3′) and the topological data (T1, T2 and T3).

With reference to FIGS. 2 and 4, at step S113, the second neutral file 204a is imported into the CAE system 206. The second neutral file 204a exported from the CAD system 201 as shown in FIG. 3 is imported into the CAE system 206 as shown in FIG. 4. Since the second neutral file 204a is in a neutral, generic or non-proprietary file format, the second neutral file 204a is readable and accessible by the CAE system 206. In some embodiments, the first modified design model 202a generated by the CAD system 201 as shown in FIG. 3 is transformed into a first modified mesh model 207a by the CAE system 206 as shown in FIG. 4 after the importation of the second neutral file 204a into the CAE system 206.

In some embodiments, the first modified mesh model 207a is generated prior to an analysis of the first modified design model 202a imported into the CAE system 206. In some embodiments, the first modified mesh model 207a is generated by dividing the first modified design model 202 into a plurality of small parts in a grid form for subsequent analysis. In other words, the mesh model 207 is refreshed to become the first modified mesh model 207a.

In some embodiments, the second mapping 210 is established. In some embodiments, the second label is transformed into the third label based on the second mapping 210 established at the step S105 and stored in the CAE system 206 during the importation of the second neutral file 204a into the CAE system 206.

For example, as shown in FIG. 4, the second labels (1, 2 and 3) are transformed respectively into the third labels (X, Y and Z). As a result, in a first modified CAE information file 208a, the third labels (X, Y and Z) are associated correspondingly with the first modified geometrical data G1′, the other geometrical data (G2′ and G3′) and the topological data (T1, T2 and T3). The CAE information file 208 is refreshed to become the first modified CAE information file 208a.

With reference to FIGS. 2 and 4, at step S114, the first modified design model 202a is analyzed by the CAE system 206. In some embodiments, the first modified design model 202a is transformed into the first modified mesh model 207a, and the analysis is performed on the first modified mesh model 207a. Each object entity is divided into small parts in the grid form and analyzed by the CAE system 206 based on a predetermined condition. In some embodiments, the analysis can be any type of engineering analysis generally known in the art.

In some embodiments, a modified analysis result of the first modified mesh model 207a is obtained from the CAE system. In some embodiments, the modified analysis result is associated with the analysis of the object entity of the first modified mesh model 207a. In some embodiments, the method S100 will be terminated if the modified analysis result is satisfactory such that no further optimization of the first modified design model 202a is required.

Alternatively, the method S100 will continue if the modified analysis result is still not satisfactory. The modified analysis result is then exported for subsequent optimization. With reference to FIGS. 4 and 5, the modified analysis result is exported from the CAE system 206 and then imported into the optimization system 211 for optimization of the first modified design model 202a.

For example, as shown in FIGS. 4 and 5, the first modified mesh model 207a is analyzed by the CAE system 206, and the modified analysis results (R1′, R2′ and R3′) are obtained from the CAE system 206. In some embodiments, a modified analysis result file 209a is generated by the CAE system 206. In some embodiments, the third labels (X, Y and Z) are transformed respectively into the second labels (1, 2 and 3) based on the second mapping 210 stored in the CAE system 206. The modified analysis result file 209a includes the second labels (1, 2 and 3) and the modified analysis results (R1′, R2′ and R3′).

In some embodiments, the modified analysis result file 209a is exported from the CAE system 206 as shown in FIG. 4, and then imported into the optimization system 211 as shown in FIG. 5. In some embodiments, the modified analysis result file 209a is in a neutral, generic or non-proprietary file format. In some embodiments, the modified analysis result file 209a can be in any suitable proprietary or non-proprietary file format. In some embodiments, the modified analysis result file 209a generated by the CAE system 206 is readable and accessible by the optimization system 211. In some embodiments, the CAE system 206 is actuated prior to the importation of the second neutral file 204a into the CAE system 206. In some embodiments, the CAE system 206 is actuated by the first user scripting.

In some embodiments, the method S100 further includes steps S115 to S 118 as shown in FIG. 2. In some embodiments, the steps S 115 to S118 are implemented after the step S114 discussed above and shown in FIG. 1. In some embodiments, the method S100 can be continuous from steps S101 to S118 as shown in FIGS. 1 and 2.

With reference to FIGS. 2 and 5, at step S 115, a second modified geometrical data for the object entity is derived based on the analysis for optimizing the first modified design model 202a by the optimization system 211. In some embodiments, the second modified geometrical data is derived based on the analysis performed at the step S114. In some embodiments, an optimization of the first modified design model 202a is performed by the optimization system 211. In some embodiments, the optimization is performed based on the modified analysis result from the CAE system 206.

For example, as shown in FIG. 5, the modified analysis result file 209a from the CAE system 206 is imported into the optimization system 211, and then the second modified geometrical data G1″ is derived. In some embodiments, the other modified geometrical data (G2″ and G3″) are also derived. As a result, in a modified optimization information file 212a, the second modified geometrical data G1″ is associated with the second label 1. In some embodiments, the other modified geometrical data {G2″ and G3″) are associated with the second labels (2 and 3 respectively). In other words, optimization of the first modified design model 202a is achieved by modifying the first modified geometrical data G1′ into the second modified geometrical data G1″ according to an optimization result from the optimization system 211. In order to obtain an optimized design model, it is necessary to modify the first modified geometrical data G1′ for the object entity associated with the second label 1 into the second modified geometrical data G1″. In some embodiments, it is also necessary to modify the other modified geometrical data (G2′ and G3′) for the object entity associated with the second labels (2 and 3 respectively) into the other modified geometrical data (G2″ G3″ respectively).

With reference to FIGS. 2 and 5, at step S1 16, a second data file 213a is exported from the optimization system 211. In some embodiments, the second data file 213a includes the second modified geometrical data for the object entity, and the second label derived from the third label based on the second mapping 210 in the CAE system 206. In some embodiments, the second data file 213a includes the second label, the second modified geometrical data and the topological data. In some embodiments, the second data file 213a is in a neutral, generic or non-proprietary file format. In some embodiments, the second data file 213a is in STEP file format, DWG file format, STL file format, DXT file format or any other suitable non-proprietary file format. In some embodiments, the second data file 213a generated by the optimization system 211 is readable and accessible by the CAD system 201.

For example, as shown in FIG. 5, the second data file 213a is exported from the optimization system 211. The second data file 213a includes the second label 1, the second modified geometrical data G1″ and the topological data T1. In some embodiments, the second label 1 and the topological data T1 are copied from the modified analysis result file 209a to the second data file 213a. In some embodiments, the second data file 213a further includes the second label 2, the other modified geometrical data G2″ and the topological data T2. In some embodiments, the second label 2 and the topological data T2 are copied from the modified analysis result file 209a to the second data file 213a. In some embodiments, the second data file 213a further includes the second label 3, the other modified geometrical data G3″ and the topological data T3. In some embodiments, the second label 3 and the topological data T3 are copied from the modified analysis result file 209a to the second data file 213a.

With reference to FIGS. 2 and 3, at step S 117, the second data file 213a is imported into the CAD system 201. In some embodiments, the second data file 213a generated by the optimization system 211 as shown in FIG. 5 is imported into the CAD system 201 as shown in FIG. 3. In some embodiments, the second label is transformed into the first label based on the first mapping 205 stored in the CAD system 201. The first mapping 205 is established at the step S103. In some embodiments, the transformation of the second label into the first label is performed during the importation of the second data file 213a into the CAD system 201. In some embodiments, the second data file 213a including the second label, the second modified geometrical data and the topological data is imported into the CAD system 201.

In some embodiments, the CAD system 201 is actuated prior to the importation of the second data file 213a into the CAD system 201. In some embodiments, the CAD system 201 is actuated by the second user scripting.

With reference to FIGS. 2 and 3, at step S118, the first modified geometrical data of the object entity assigned the first label is replaced by the second modified geometrical data in the second data file 213a to generate a second modified design model 202b in the CAD system 201. Since the first label corresponds to the second label based on the first mapping stored in the CAD program 201, the first modified geometrical data associated with the first label is replaced by the second modified geometrical data associated with the second label. In some embodiments, the first modified geometrical data is replaced with the second modified geometrical data by removing the first modified geometrical data and inserting the second modified geometrical data from the second data file.

After the replacement of the first modified geometrical data with the second modified geometrical data, the first modified design model 202a is refreshed to become the second modified design model 202b by the CAD system 201. In some embodiments, the first modified design model 202a is optimized to become the second modified design model 202b according to the optimization result from the optimization system 211. In some embodiments, the topological data (T1, T2 and T3) remain unchanged. The topological data (T1, T2 and T3) in the first modified CAD information file 203a are same as the topological data (T1, T2 and T3) in a second modified CAD information file 203b.

For example, as shown in FIG. 3, the first mapping 205 is established at step S103 and stored in the CAD system 201. The first labels (A, B and C) correspond respectively to the second labels (1, 2 and 3). Based on the first mapping 205, the first modified geometrical data G1′ associated with the first label A is replaced by the second modified geometrical data G1″ associated with the second label 1 in the second data file 213a. In some embodiments, based on the first mapping 205, the other modified geometrical data G2′ associated with the first label B is replaced by the other modified geometrical data G2″ associated with the second label 2 in the second data file 213a, and the other modified geometrical data G3′ associated with the first label C is replaced by the other modified geometrical data G3″ associated with the second label 3 in the second data file 213a. Subsequently, the second modified design model 202b is generated by the CAD system 201.

For example, as shown in FIG. 3, the second modified geometrical data G1″ is shrinkage of the object entity assigned the first label A. As such, the object entity assigned the first label A in the second modified design model 202b is reduced compared to the object entity assigned the first label A in the first modified design model 202a. As a result, in the second modified CAD information file 203b, the first label A is now associated with the second modified geometrical data G1″ and the topological data T1. In some embodiments, the remainder of the first labels (B and C) are associated correspondingly with the geometrical data (G2″ and G3″) and the topological data (T2 and T3).

In some embodiments, after the replacement of the first modified geometrical data with the second modified geometrical data in the second data file 213a, the second modified design model 202b is provided by the CAD system 201 in a manner similar to that of the step S111 as discussed above. In some embodiments, a third neutral file 204b is exported from the CAD system 201 in a manner similar to that of the step S112 as discussed above. In some embodiments, the third neutral file 204b is imported into the CAE system 206 in a manner similar to that of the step S113 as discussed above. In some embodiments, the second modified design model 202b is analyzed by the CAE system 206 in a manner similar to that of the step S114 as discussed above.

In some embodiments, the steps S111 to S118 are repeated until the optimization result of the design model is satisfactory or an optimal design model is obtained so that no further optimization is required.

One aspect of the present disclosure provides a method of optimizing a design model. The method includes providing the design model in a CAD system, wherein the design model includes an object entity represented by a geometrical data and a topological data; assigning a first label to the object entity in the CAD system; transforming the first label into a second label to establish a first mapping in the CAD system; exporting a first neutral file of the design model including the second label, the geometrical data and the topological data from the CAD system; importing the first neutral file into a CAE system and transforming the second label into a third label to establish a second mapping in the CAE system; analyzing the design model by the CAE system; deriving a first modified geometrical data for the object entity based on the analysis for optimizing the design model by an optimization system; exporting a first data file including the first modified geometrical data for the object entity and the second label derived from the third label based on the second mapping stored in the CAE system; importing the first data file into the CAD system and transforming the second label into the first label based on the first mapping stored in the CAD system; and replacing the geometrical data of the object entity assigned the first label with the first modified geometrical data in the first data file to generate a first modified design model in the CAD system.

Another aspect of the present disclosure provides a method of optimizing a design model. The method includes providing the design model in a CAD system, wherein the design model includes a first object entity represented by a first geometrical data and a first topological data, and a second object entity represented by a second geometrical data and a second topological data; assigning a first label to the first object entity and a second label to the second object entity in the CAD system; transforming the first label and the second label into a third label and a fourth label, respectively, to establish a first mapping in the CAD system; exporting a neutral file of the design model including the third label, the first geometrical data, the first topological data, the fourth label, the second geometrical data and the second topological data from the CAD system; importing the neutral file into a CAE system and transforming the third label and the fourth label into a fifth label and a sixth label, respectively, to establish a second mapping in the CAE system; analyzing the design model by the CAE system; deriving a modified geometrical data for the first object entity indicated by the fifth label based on the analysis for optimizing the design model by an optimization system; exporting a data file including the modified geometrical data for the first object entity indicated by the third label derived from the fifth label based on the second mapping stored in the CAE system; importing the data file into the CAD system and transforming the third label into the first label based on the first mapping stored in the CAD system; and replacing the first geometrical data of the object entity assigned the first label with the first modified geometrical data in the first data file to generate a modified design model in the CAD system, wherein the first topological data, the second geometrical data and the second topological data remain unchanged.

Due to the generation and exportation of the design model in a neutral file format by the CAD system and the importation of the design model in the neutral file format into the CAE system for analysis and optimization, the design model in the neutral file format is readable and accessible by the CAD system and the CAE system, without involving a database or libraries at core levels of the CAD system and the CAE system. Therefore, integration of the CAD system and the CAE system is not required. The CAD system and the CAE system can be operated separately without license or authorization from each other.

It should be noted that, in the description of the present disclosure, the functions or steps noted herein may occur in an order different from the order noted in the figures. For example, two figures shown in succession may in fact be executed substantially concurrently or may sometimes be executed in a reversed order, depending upon the functionalities or steps involved.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

What is claimed is:

1. A method of optimizing a design model, comprising:
providing the design model in a CAD system, wherein the design model includes an object entity represented by a geometrical data and a topological data;
assigning a first label to the object entity in the CAD system;
transforming the first label into a second label to establish a first mapping in the CAD system;
exporting a first neutral file of the design model including the second label, the geometrical data and the topological data from the CAD system;
importing the first neutral file into a CAE system and transforming the second label into a third label to establish a second mapping in the CAE system;
analyzing the design model by the CAE system;
deriving a first modified geometrical data for the object entity based on the analysis for optimizing the design model by an optimization system;
exporting a first data file including the first modified geometrical data for the object entity, and the second label derived from the third label based on the second mapping stored in the CAE system;
importing the first data file into the CAD system and transforming the second label into the first label based on the first mapping stored in the CAD system; and
replacing the geometrical data of the object entity assigned the first label with the first modified geometrical data in the first data file to generate a first modified design model in the CAD system.

2. The method of claim 1, wherein the topological data of the object entity remains unchanged.

3. The method of claim 1, wherein the first neutral file and the first data file are in a neutral, generic or non-proprietary file format.

4. The method of claim 1, wherein the first neutral file and the first data file are in STEP file format, DWG file format, STL file format or DXT file format.

5. The method of claim 1, wherein the optimization system is external to the CAD system and the CAE system.

6. The method of claim 1, further comprising:
actuating the CAE system by a first user scripting prior to the importation of the first neutral file into the CAE system;
actuating the CAD system by a second user scripting prior to the importation of the first data file into the CAD system.

7. The method of claim 1, further comprising transforming the design model into a mesh model by the CAE system prior to the analysis of the design model.

8. The method of claim 1, wherein a native file in a proprietary file format is generated by or exported from the CAD system during the exportation of the first neutral file.

9. The method of claim 8, wherein only the first neutral file is imported into the CAE system.

10. The method of claim 8, wherein the native file is readable and accessible exclusively by the CAD system, and the first neutral file is readable and accessible by the CAD system and the CAE system.

11. The method of claim 1, further comprising:
providing the first modified design model in the CAD system, wherein the first modified design model includes the object entity assigned the first label and represented by the first modified geometrical data and the topological data;
exporting a second neutral file of the first modified design model including the second label derived from the first label based on the first mapping, the first modified geometrical data and the topological data from the CAD system;
importing the second neutral file into the CAE system;
analyzing the first modified design model by the CAE system.

12. The method of claim 11, wherein the topological data of the first modified object entity remains unchanged.

13. The method of claim 11, wherein the second neutral file is in a neutral, generic or non-proprietary file format.

14. The method of claim 11, wherein the second neutral file is in STEP file format, DWG file format, STL file format or DXT file format.

15. The method of claim 11, further comprising:
deriving a second modified geometrical data for the object entity based on the analysis for optimizing the first modified design model by the optimization system;
exporting a second data file including the second modified geometrical data for the object entity, and the second label derived from the third label based on the second mapping stored in the CAE system;
importing the second data file into the CAD system and transforming the second label into the first label based on the first mapping stored in the CAD system; and
replacing the first modified geometrical data of the object entity assigned the first label with the second modified geometrical data in the second data file to generate a second modified design model in the CAD system.

16. The method of claim 15, wherein the second modified design model is generated by changing a dimension of the object entity of the first modified design model.

17. The method of claim 15, wherein the replacement of the first modified geometrical data with the second modified geometrical data includes removing the first modified geometrical data and inserting the second modified geometrical data from the second data file.

18. The method of claim 15, further comprising:
providing the second modified design model in the CAD system, wherein the second modified design model includes the object entity assigned the first label and represented by the second modified geometrical data and the topological data;
exporting a third neutral file of the second modified design model including the second label derived from the first label based on the first mapping stored in the CAD system, the second modified geometrical data and the topological data from the CAD system;
importing the third neutral file into the CAE system; and
analyzing the second modified design model by the CAE system.

19. A method of optimizing a design model, comprising:
providing the design model in a CAD system, wherein the design model includes a first object entity represented by a first geometrical data and a first topological data, and a second object entity represented by a second geometrical data and a second topological data;
assigning a first label to the first object entity and a second label to the second object entity in the CAD system;
transforming the first label into a third label and transforming the second label into a fourth label to establish a first mapping in the CAD system;
exporting a neutral file of the design model including the third label, the first geometrical data, the first topological data, the fourth label, the second geometrical data and the second topological data from the CAD system;
importing the neutral file into a CAE system and transforming the third label into a fifth label and transforming the fourth label into a sixth label to establish a second mapping in the CAE system;
analyzing the design model by the CAE system;
deriving a modified geometrical data for the first object entity indicated by the fifth label based on the analysis for optimizing the design model by an optimization system;
exporting a data file including the modified geometrical data for the first object entity indicated by the third label derived from the fifth label based on the second mapping stored in the CAE system;
importing the data file into the CAD system and transforming the third label into the first label based on the first mapping stored in the CAD system; and
replacing the first geometrical data of the object entity assigned the first label with the first modified geometrical data in the first data file to generate a modified design model in the CAD system,
wherein the first topological data, the second geometrical data and the second topological data remain unchanged.

20. The method of claim 19, wherein the modified design model includes the first object entity represented by the first modified geometrical data and the first topological data, and the second object entity represented by the second geometrical data and the second topological data.
